(19) United States
(12) Patent Application Publication
(10) Pub. No.: US 2025/0158915 A1
(43) Pub. Date: May 15, 2025

(54) SYSTEM AND METHOD FOR BIG TYPE LENGTH VALUE ENCODING IN AN IS-IS NETWORK

(71) Applicant: HUAWEI TECHNOLOGIES CO., LTD., Shenzhen Guangdong Province (CN)

(72) Inventors: Huaimo Chen, Bolton, MA (US); Donald Eggleston Eastlake, III, Apopka, FL (US)

(21) Appl. No.: 19/022,426

(22) Filed: Jan. 15, 2025

Related U.S. Application Data
(63) Continuation of application No. PCT/US2023/031558, filed on Aug. 30, 2023.
(60) Provisional application No. 63/402,224, filed on Aug. 30, 2022.

(51) Int. Cl. H04L 45/03

(52) U.S. Cl. CPC H04L 45/03

(57) ABSTRACT

A method performed by a routing device. The method comprises determining that a size of a payload of a type-length-value (TLV) of a first type in a link state protocol data unit exceeds a maximum value, splitting the payload into n pieces, wherein n is an integer larger than 1, and encoding a first piece of the payload in a first TLV of the first type. The first TLV of the first type includes a first type field indicating the first type, a first value field including the first piece of the payload and a first length field indicating a length of the first value field. The method includes encoding one or more second pieces of the payload in one or more container TLVs of a second type.

### CROSS-REFERENCE TO RELATED APPLICATIONS

This is a continuation of International Application No. PCT/US2023/031558, filed Aug. 30, 2023, entitled “System and Method for Big Type Length Value Encoding in an IS-IS Network,” which claims the benefit of U.S. Provisional Patent No. 63/402,224, filed Aug. 30, 2022, entitled “ISIS BIG TLV ENCODING AND PROCESSING,” both of which are incorporated herein by reference in their entirety.

### BACKGROUND

An Intermediate System to Intermediate System (IS-IS) network is a single network domain that may include end systems and intermediate systems. End systems are network entities that send and receive packets. Intermediate systems send and receive packets and relay (or forward) the packets. The IS-IS protocol is an interior gateway protocol (IGP) that uses link-state information to make routing decisions.

Type-Length-Value (TLV) encoding of information is widely used in IS-IS routing protocol messages, including Link State Protocol Data Units (PDUs) (Link State PDUs referred to herein as LSPs). Each TLV allows for a maximum of 255 octets of value (or payload). This is because the length field of the TLV is one octet (or byte), which has a maximum value of 255. This limits the TLV encoding scope.

### SUMMARY

A first aspect relates to a method performed by a routing device. The method comprises determining that a size of a payload of a type-length-value (TLV) of a first type in a link state protocol data unit exceeds a maximum value, splitting the payload into n pieces, wherein n is an integer larger than 1, encoding a first piece of the payload in a first TLV of the first type, wherein the first TLV of the first type includes a first type field indicating the first type, a first value field including the first piece of the payload and a first length field indicating a length of the first value field. The method also includes encoding one or more second pieces of the payload in one or more container TLVs of a second type, wherein each container TLV of the second type comprises a second type field indicating the second type, a second value field and a second length field indicating a length of the second value field, wherein the second value field includes a third type field indicating the first type and a piece field including the second piece of the payload.

Optionally, in any of the preceding aspects, another implementation of the aspect includes wherein the maximum value is 255 octets, the first value field of the first TLV has a size not larger than the maximum value, and the second value field of each container TLV has a size not larger than the maximum value.

Optionally, in any of the preceding aspects, another implementation of the aspect includes wherein each container TLV includes at least one of a flag indicating whether the piece in the container TLV is a final piece of the payload, an order field indicating an order of the pieces of the payload, or an instance field identifying which instance of the TLV the container TLV is part of.

Optionally, in any of the preceding aspects, another implementation of the aspect includes transmitting a TLV capability flag to a neighbor of the routing device, the TLV capability flag indicating supporting a big TLV of the first type including a value field with a size larger than the maximum value.

Optionally, in any of the preceding aspects, another implementation of the aspect includes wherein the one or more container TLVs follow the first TLV in order without any other TLV therebetween.

A second aspect relates to a routing device comprising a processor and a non-transitory memory storing programing instructions that, when executed by the processor, cause the routing device to perform the method of any of the preceding implementations.

A third aspect relates to a non-transitory computer readable medium comprising a computer program product for use by a routing device, the computer program product comprising computer executable instructions stored on the non-transitory computer readable medium that, when executed by one or more processors, cause the routing device to execute the method of any of the preceding implementations.

A fourth aspect relates to a method performed by a routing device. The method comprises determining that a size of a payload of a type-length-value (TLV) of a first type in a link state protocol data unit exceeds a maximum value, splitting the payload into n pieces, wherein n is an integer larger than 1, and encoding the n pieces of the payload in a plurality of container TLVs of a second type. Each container TLV includes a second type field indicating the second type, a second value field, and a second length field indicating a length of the second value field, wherein the second value field of each container TLV includes a third type field indicating the first type and a piece field including the piece of the payload.

Optionally, in any of the preceding aspects, another implementation of the aspect includes wherein the maximum value is 255 octets, the first value field of the first TLV has a size not larger than the maximum value, and the second value field of each container TLV has a size not larger than the maximum value.

Optionally, in any of the preceding aspects, another implementation of the aspect includes wherein each container TLV includes at least one of a flag indicating whether the piece in the container TLV is a final piece of the payload, an order field indicating an order of the pieces of the payload, or an instance field identifying which instance of the TLV the container TLV is part of.

Optionally, in any of the preceding aspects, another implementation of the aspect further comprises transmitting a TLV capability flag to a neighbor of the routing device, the TLV capability flag indicating supporting a big TLV of the first type including a value field with a size larger than the maximum value.

A fifth aspect relates to a routing device comprising a processor and a non-transitory memory storing programing instructions that, when executed by the processor, cause the routing device to perform the method of any of the preceding implementations.

A sixth aspect relates to a non-transitory computer readable medium comprising a computer program product for use by a routing device, the computer program product comprising computer executable instructions stored on the non-transitory computer readable medium that, when executed by one or more processors, cause the routing device to execute the method of any of the preceding implementations.

A seventh aspect relates to a method performed by a routing device. The method comprises receiving a plurality of type-length-values (TLVs) in one or more link state protocol data units. The plurality of TLVs includes a first TLV of a first type and one or more container TLVs of a second type. The first TLV of the first type includes a first type field indicating the first type, a first length field indicating a length of a first value field and the first value field including a first piece of the payload. Each container TLV of the second type comprises a second type field indicating the second type, a second value field and a second length field indicating a length of the second value field, wherein the second value field includes a third type field indicating the first type and a piece field including a second piece of the payload.

An eighth aspect relates to a routing device comprising a processor and a non-transitory memory storing programing instructions that, when executed by the processor, cause the routing device to perform the method of any of the preceding implementations.

A ninth aspect relates to a non-transitory computer readable medium comprising a computer program product for use by a routing device, the computer program product comprising computer executable instructions stored on the non-transitory computer readable medium that, when executed by one or more processors, cause the routing device to execute the method of any of the preceding implementations.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic diagram of a network topology including an Interior Gateway Protocol (IGP) domain.

FIG. 2 is a schematic diagram of a routing device according to an embodiment of the disclosure.

FIG. 3 is a flow diagram of a method in the routing device of FIG. 2 according to an embodiment of the disclosure.

FIG. 4 is a diagram of a big Type Length Value (TLV) with a payload bigger than 255 bytes according to an embodiment of the disclosure.

FIG. 5 is a diagram of encoding a big TLV with n minus 1 new TLVs of type (TBD) according to an embodiment of the disclosure.

FIG. 6 is a diagram of the format of a container TLV for a big TLV according to an embodiment of the disclosure.

FIG. 7 is a diagram of the format of a container TLV for a big TLV according to an embodiment of the disclosure.

FIG. 8 is a diagram of the format of a container TLV for a big TLV that includes selected flags values according to an embodiment of the disclosure.

FIG. 9 is a diagram of the format of a container TLV for a big TLV that includes version and instance values according to an embodiment of the disclosure.

FIG. 10 is a diagram of a big TLV of type (T) with a 600-byte value field according to an embodiment of the disclosure.

FIG. 11 is a diagram of an encoding of the big TLV of type (T) in FIG. 10 by a normal TLV of type (T) and two (2) container TLVs according to an embodiment of the disclosure.

FIG. 12 is a diagram of an encoding of the big TLV of type (T) in FIG. 10 by three (3) container TLVs according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The present disclosure describes apparatuses and methods to support a backward compatible IS-IS extension for encoding a TLV structure whose value is bigger than 255 octets. The IS-IS routing protocol uses TLV (Type-Length-Value) encoding in a variety of protocol messages. The original IS-IS TLV definition allows a maximum of 255 octets (or bytes) of value. According to the principles of the present disclosure, when the payload of a TLV structure (or unit) of a type (T) is bigger than 255 octets, the payload is split into a number of pieces. The first payload piece is not bigger than 255 octets and each of the other payload pieces is less than 254 octets.

The present disclosure describes an IS-IS extension for encoding and distributing the big TLV structures whose value parts are bigger than can be accommodated by the TLV length field and can encode and distribute big TLV structures whose value parts are bigger than can be accommodated in a single packet. As used herein, a TLV structure having a payload of not bigger than 255 bytes and a type (T) may be referred to as a “normal TLV structure of type (T)” or more simply as a “TLV” or a “TLV of type (T)”. Similarly, a TLV structure having a payload of more than 255 bytes and a type (T) may be referred to as a “big TLV structure of type (T)” or more simply as a “big TLV” or a “big TLV of type (T)”.

Additionally, a new TLV structure, called a “container TLV” with a new “type (TBD)” is defined. The container TLV structure of type (TBD) may be referred to as a “container TLV of type (TBD)” or more simply as a “container TLV”. For each piece of the payload from a big TLV of type (T), a new container TLV with type (TBD) is used to carry the piece and type (T) information.

The container TLV may include:
1) a type (TBD) field that defines the type of the container TLV. The value of Type (TBD) is assigned by the Internet Assigned Numbers Authority (IANA). “TBD” herein is short for “to be determined”, representing that the value is to be determined or assigned.
2) a length field that defines the length of the value field of the container TLV.
3) a value field that contains a big TLV identifier field with a value type (T) identifying the big TLV, a reserved (Resv) field, and a piece of value of big TLV of type (T) (“Piece field” for short).

The big TLV identifier field includes a value T identifying the big TLV to which the piece in the container TLV belongs.

The piece field includes a piece of the value of the big TLV that is being transported in the container TLV.

The Resv field that is a one octet field that may be sent as zero and ignored on receipt.

According to the principles of the present disclosure, when a routing device (e.g., a node) has a big TLV of type (T) to be originated, the node splits the value of the big TLV into a number of pieces, from Piece 1 up to Piece n. The first piece (i.e., Piece 1) may be less than 256 octets. Each of the remaining pieces from Piece 2 to Piece n may be less than 254 octets.

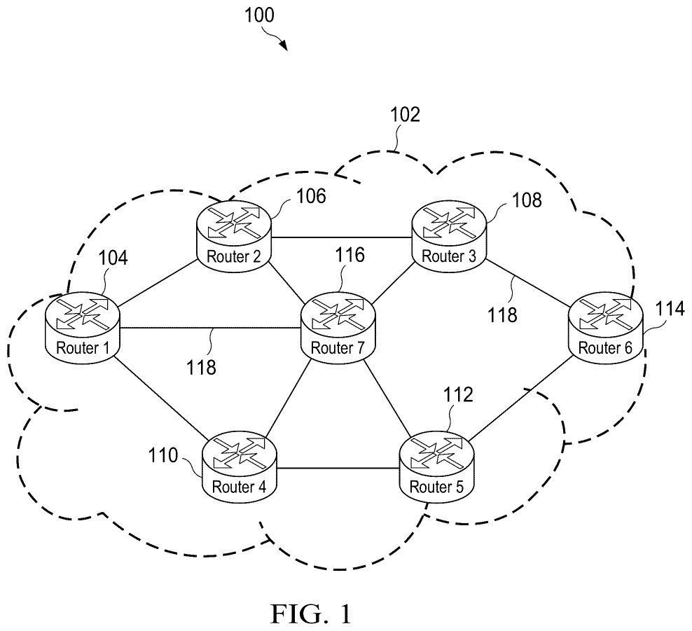

FIG. 1 is a schematic diagram of a network topology 100 including an Interior Gateway Protocol (IGP) domain 102. Thus, the network nodes (e.g., routers or routing devices) utilize open shortest path first (OSPF) or Intermediate System-Intermediate System (IS-IS) to route Internet Protocol (IP) packets (or simply, packets) in the IGP domain of an IP network.

The IGP domain 102 comprises a plurality of network nodes 104, 106, 108, 110, 112, 114, and 116. While seven network nodes 104-116 are shown in the IGP domain 102, more or fewer network nodes may be included in practical applications. In an embodiment, the network nodes 104-116 comprise a router, a switch, or other network device capable of routing packets through the IGP domain 102.

Some of the network nodes, e.g., network nodes 104, 114, are disposed at an edge of the IGP domain 102. The network nodes 104, 114 receiving packets from outside the IGP domain 102 may be referred to as ingress network nodes. The network nodes 104, 114, transmitting packets out of the IGP domain 102 may be referred to as egress network nodes. Depending on the direction of multicast packet traffic, either of the network nodes 104, 114 may function as an ingress network node or an egress network node. While not shown, the network nodes disposed at an edge of the IGP domain 102 may be coupled to nodes disposed outside the IGP domain 102. The network nodes that are not disposed at an edge of the IGP domain 102, e.g., network nodes 108, 110, 116, may be referred to intermediate network nodes, internal network nodes, or transit nodes.

The network nodes 104-116 are coupled to each other via links 118. The links 118 may be wired, wireless, or some combination thereof. As discussed more fully below, each of the links 118 have a cost based, for example, on the bandwidth of the link.

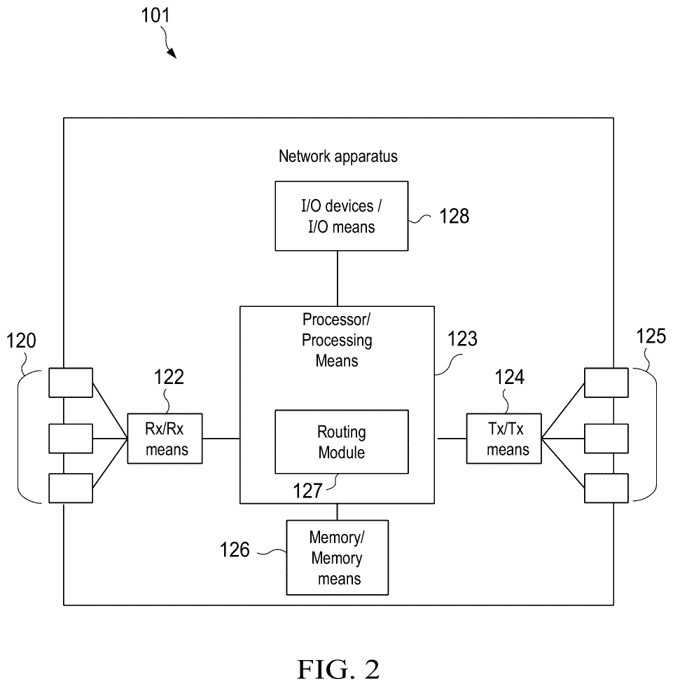

FIG. 2 is a schematic diagram of a routing device 101 (e.g., a network node, a network router, a router, etc.). The routing device 101 may be any one of the network nodes 104, 106, 108, 110, 112, 114, and 116. The routing device 101 is suitable for implementing the disclosed embodiments as described herein. The routing device 101 comprises ingress ports/ingress means 120 (a.k.a., upstream ports) and receiver units (Rx)/receiving means 122 for receiving data; a processor, logic unit, or central processing unit (CPU)/processing means 123 to process the data; transmitter units (Tx)/transmitting means 124 and egress ports/egress means 125 (a.k.a., downstream ports) for transmitting the data; and a memory/memory means 126 for storing the data. The routing device 101 may also comprise optical-to-electrical (OE) components and electrical-to-optical (EO) components coupled to the ingress ports/ingress means 120, the receiver units/receiving means 122, the transmitter units/transmitting means 124, and the egress ports/egress means 125 for egress or ingress of optical or electrical signals.

The processor/processing means 123 is implemented by hardware and software. The processor/processing means 123 may be implemented as one or more CPU chips, cores (e.g., as a multi-core processor), field-programmable gate arrays (FPGAs), application specific integrated circuits (ASICs), and digital signal processors (DSPs). The processor/processing means 123 is in communication with the ingress ports/ingress means 120, receiver units/receiving means 122, transmitter units/transmitting means 124, egress ports/egress means 125, and memory/memory means 126. The processor/processing means 123 comprises a routing module 127. The routing module 127 is able to implement the methods disclosed herein. The inclusion of the routing module 127 therefore provides a substantial improvement to the functionality of the routing device 101 and effects a transformation of the routing device 101 to a different state. Alternatively, the routing module 127 is implemented as instructions stored in the memory/memory means 126 and executed by the processor/processing means 123.

The routing device 101 may also include input and/or output (I/O) devices or I/O means 128 for communicating data to and from a user. The I/O devices or I/O means 128 may include output devices such as a display for displaying video data, speakers for outputting audio data, etc. The I/O devices or I/O means 128 may also include input devices, such as a keyboard, mouse, trackball, etc., and/or corresponding interfaces for interacting with such output devices.

The memory/memory means 126 comprises one or more disks, tape drives, and solid-state drives and may be used as an over-flow data storage device, to store programs when such programs are selected for execution, and to store instructions and data that are read during program execution. The memory/memory means 126 may be volatile and/or non-volatile and may be read-only memory (ROM), random access memory (RAM), ternary content-addressable memory (TCAM), and/or static random-access memory (SRAM).

If a node (e.g., routing device 101) supports the extension (i.e., container TLV), the node understands each piece of the value of the big TLV received. The value field in the normal TLV of type (T) contains Piece 0 of the big TLV value. Each of the (n−1) (i.e., n minus 1) container TLVs having type (TBD) contains a piece of the big TLV value in its Piece field.

When a TLV of type (T) is too big at an originating node, the node (e.g., routing device 101) splits the big TLV into a sequence of pieces. Each piece carries a subset of entries in the big TLV. An entry is an existing sub-TLV or structure. According to some embodiments, originating node may or may not generate the “big TLV of type (T)” and the payload can be a payload before encoding to any TLV.

The node originates a native/normal TLV of type (T) containing the first piece in the sequence. In addition, the node originates container TLVs with type (TBD) containing the other pieces if there is only one big TLV of type (T).

When there are multiple big TLVs of type (T), the node originates multiple native/normal TLVs of type (T). For each big TLV of type (T) split into a sequence of pieces, a native/normal TLV of type (T) containing the first piece in the sequence is originated. The container TLVs with type (TBD) containing the other pieces are also originated. In an embodiment, these container TLVs follow the native/normal TLV in order. Between the native/normal TLV and these container TLVs there are no other TLVs of type (T) or other container TLVs with type (TBD).

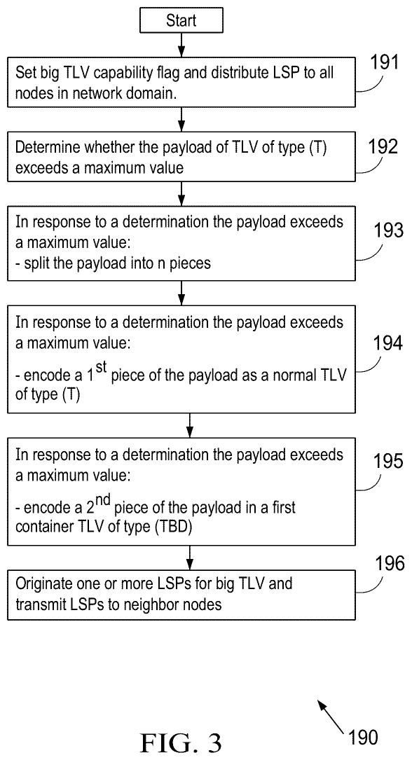

FIG. 3 is a flow diagram 190 of a method in the routing device 101 of FIG. 2 according to an embodiment of the disclosure. In step 191, the routing device 101 sets a big TLV capability flag in an LSP to a value indicating that the routing device 101 supports big TLVs. The LSP with the flag is distributed to every node in the network domain. In an embodiment, the flag is one bit and the value of the flag is set to one (1) indicating that the routing device 101 supports big TLVs.

In step 192, the routing device 101 determines whether the payload of a TLV of type (T) that the routing device 101 originates exceeds a maximum value, such as 255 bytes. In step 193, in response to a determination that the payload does exceed the maximum value and the TLV is a big TLV of type (T), the routing device 101 splits the payload into n pieces. In step 194, the routing device 101 encodes a first piece of the payload as a normal TLV of type (T). As noted above, a normal TLV of type (T) refers to a TLV structure capable of containing up to a maximum of 255 bytes. The normal TLV includes a first type (T) field and a first length field. In step 195, the routing device 101 also encodes a second piece of the payload in a first container TLV of type (TBD). The first container TLV includes a first type (TBD) field, a second length field, a first big TLV identifier field, and a first piece field. The size of the first big TLV identifier field and the first piece field does not exceed a maximum of 255. The first piece field contains the second piece of the payload of a maximum of 254 bytes. In a first embodiment, the first big TLV identifier field includes a value of T indicating the big TLV to which the value in the first piece field belongs. In a second embodiment, the first big TLV identifier field includes a first number of octets following type T of the payload. The first number of octets identifying the big TLV to which the value in the first piece field belongs. In a third embodiment, the first big TLV identifier field includes value of T and a first number of octets following type T of the payload, which identifying the big TLV to which the value in the first piece field belongs.

Thereafter, the routing device 101 may encode a third piece of the payload in a second container TLV of type (TBD). The second container TLV includes a second type (TBD) field, a third length field, a second big TLV identifier field, and a second piece field. The size of the second big TLV identifier field and the second piece field does not exceed a maximum of 255. The second piece field contains the third piece of the payload of a maximum of 254 bytes. In a first embodiment, the second big TLV identifier field includes a value of T indicating the big TLV to which the value in the second piece field belongs. In a second embodiment, the second big TLV identifier field includes a first number of octets following type T of the payload. The first number of octets identifying the big TLV to which the value in the second piece field belongs. In a third embodiment, the second big TLV identifier field includes value of T and a first number of octets following type T of the payload, which identifying the big TLV to which the value in the second piece field belongs. The routing device 101 may continue to repeat step 195 until all n pieces of the payload are encoded.

In step 196, the routing device 101 originates one or more LSPs for the big TLV. In an embodiment, the routing device 101 transmits the LSPs to its neighbor nodes through the output ports 125 of routing device 101, wherein the LSPs comprise the normal TLV, the first container TLV to the last container TLV (i.e., the (n−1)^{th} container TLV).

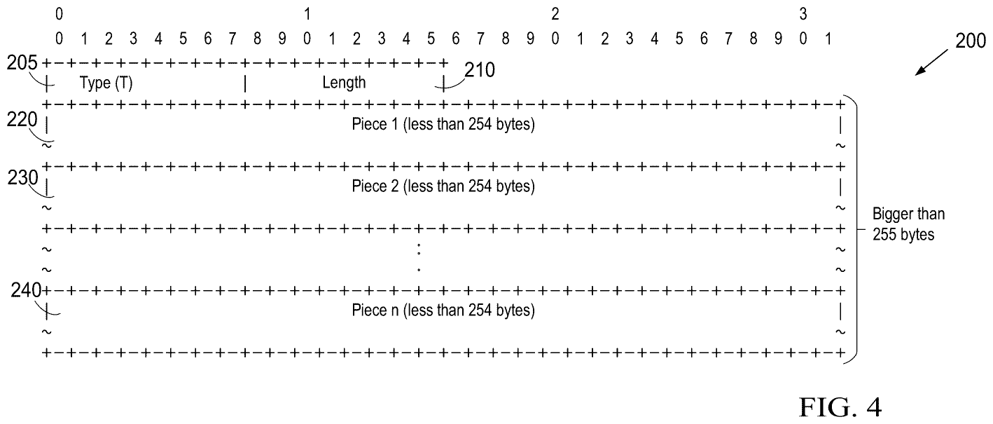

FIG. 4 is a diagram of a big type length value (TLV) with a type (T) with a payload bigger than a maximum value according to an embodiment of the disclosure. In an embodiment, the payload of the big TLV 200 is bigger than, for example, a maximum value of 255 bytes (or octets). The big TLV 200 includes a type (T) field 205, a length field 210, and n pieces of payload, including a first piece 220 (also labeled Piece 1), a second piece 230 (also labeled Piece 2), and an n^{th} piece 240 (also labeled Piece n). Each of the n pieces is less than 254 bytes (or octets). However, the sum of the n pieces is greater than 255 bytes.

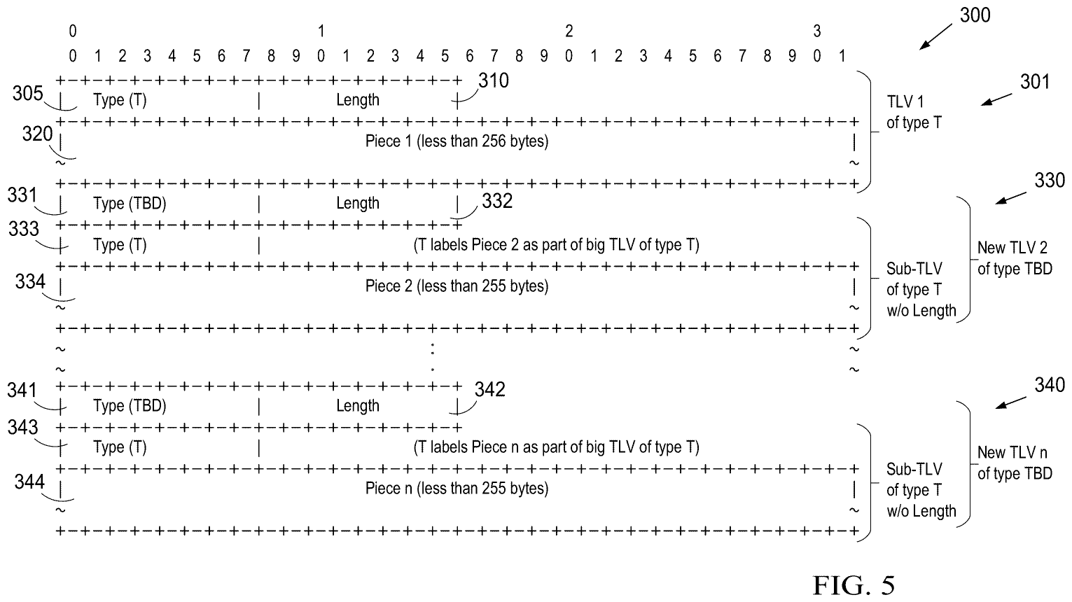

FIG. 5 is a diagram of an encoding 300 of a big TLV with (n−1) new TLVs of type (TBD) according to an embodiment of the disclosure. In an embodiment, the payload of the big TLV is bigger than a maximum value, for example, 255 bytes, and comprises n pieces. The first piece is less than 256 bytes. Each of the remaining pieces is less than 254 bytes. In FIG. 5, the routing device 101 encodes a big TLV with type (T).

The TLV 301 of type (T) includes a type (T) field 305, a length field 310, and the first piece 320 (also labeled Piece 1) of the payload of the big TLV. For each of the remaining (n−1) pieces in the payload of the big TLV, a new container TLV with type (TBD) is used to carry a piece of the payload following a big TLV identifier field with value T identifying the big TLV to which the piece in the new container TLV belongs.

By way of example, the new container TLV 330 of type (TBD) includes a type (TBD) field 331, a length field 332, a big TLV identifier field 333, and a second piece field 334 (also labeled Piece 2). The second piece field 334 contains the second piece (i.e., Piece 2) of the payload of the big TLV. The big TLV identifier field 333 includes value T identifying the big TLV to which the piece in the TLV 330 belongs.

Another new container TLV 340 of Type (TBD) includes a type (TBD) field 341, a length field 342, a big TLV identifier field 343, and the n^{th} piece field 344 (also labeled Piece n). The n^{th} piece field 344 contains the n^{th} piece (i.e., Piece n) of the payload of the big TLV. The big TLV identifier field 343 includes value T identifying the big TLV to which the piece in the TLV 340 belongs.

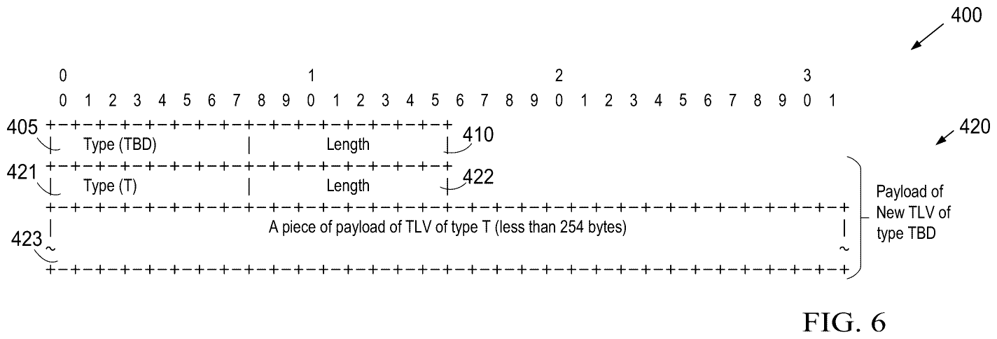

FIG. 6 is a diagram of the format of a container TLV 400 for a big TLV that includes a length field 422 for the piece of payload according to an embodiment of the disclosure. The container TLV 400 comprises a type field 405 with a value (TBD), a length field 410 with value indicating the size of the payload, and a payload (or value) field 420. The payload field 420 comprises a sub-TLV. The sub-TLV includes a type (T) field 421 with a value (T) indicating the type of a big TLV, a length field 422 with a value indicating the size of a piece 423 of payload inside the big TLV of type (T), and a piece 423 of payload of the big TLV. In an embodiment, the length field 422 in the sub-TLV may be removed. The size of the piece 423 is the value in the length field 410 of the container TLV 400 minus the size of the type (T) field 421 and the length field 422, which is two bytes.

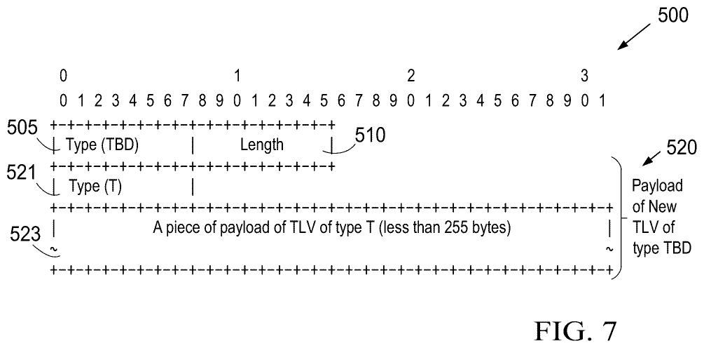

FIG. 7 is a diagram of the format of a container TLV 500 for a big TLV according to an embodiment of the disclosure. The container TLV 500 comprises a type field 505 with a value (TBD), a length field 510 with value indicating the size of the TLV excluding the type field 505 and length field 510, a big TLV identifier field 521, and a piece field 523. The piece field 523 comprises a piece of payload of the big TLV. In a first embodiment, the big TLV identifier field 521 includes value T identifying the big TLV to which the piece in the TLV 500 belongs. In a second embodiment, the big TLV identifier field 521 includes a first number of octets following type T of the payload of a big TLV. The first number of octets identifying the big TLV to which the piece in the TLV 500 belongs. In a third embodiment, the big TLV identifier field 521 includes value of T and a first number of octets following type T of the payload of a big TLV, which identifying the big TLV to which the value in the piece field 523 belongs.

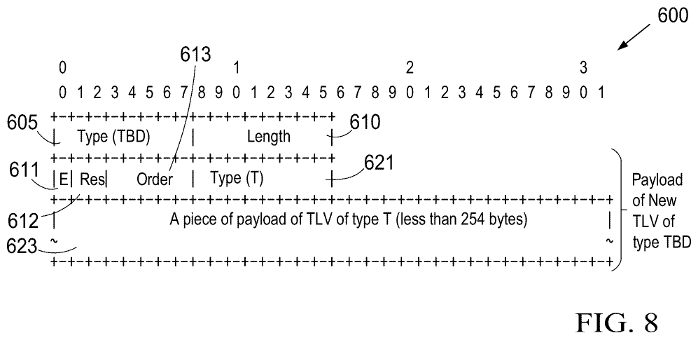

FIG. 8 is a diagram of the format of a container TLV 600 for a big TLV that includes selected flags and order values according to an embodiment of the disclosure. The container TLV 600 comprises a type field 605 with a value (TBD), a length field 610 with value indicating the size of the TLV excluding the type field 605 and the length field 610, a big TLV identifier field 621, and a piece field 623. The piece field 623 comprises a piece of payload of the big TLV. The big TLV identifier field 621 includes value T identifying the big TLV to which the piece in the TLV 600 belongs. The container TLV 600 also includes an E-flag 611, a Res field 612, and an order field 613.

An E flag 611 is a binary bit that indicates whether the container TLV 600 has the final piece of the payload of a big TLV of type (T). In an embodiment, an E-flag 611 with value of “1” in a container TLV 600 indicates that the container TLV 600 has the final piece of the payload of a big TLV of type (T). An E-flag 611 with value of “0” in a container TLV 600 in a Link State Protocol Data Unit (PDU) (LSP) indicates that the container TLV 600 does not include the final piece of the payload of a big TLV of type (T) or indicates that the piece in the container TLV 600 is not the final piece of the payload of the big TLV of type (T). The routing device 101 then is aware that there are other container TLVs in the current LSP containing the container TLV and subsequent LSPs that have other pieces, including the final piece of the payload of the big TLV of type (T). The Res field 612 comprises 2 reserved bits. The Res field 612 may be transmitted at “00” and ignored on receipt by a receiving node.

In an embodiment, the order field 613 may comprise 5 optional bits. When the order field 613 is zero (0), the order of the pieces of the payload of a big TLV is the order in which the pieces occur in some LSPs from the first LSP (i.e., LSP 0, which is the LSP with the minimum fragment number) to the last LSP (i.e., the LSP with the maximum fragment number). When the order value is an unsigned integer greater than 0, the order of the pieces of payload of the big TLV is the order in which the pieces occur in the container TLVs ordered by the values of order fields of the container TLVs.

According to some embodiments, a receiving node receives a sequence of TLVs shown in any of FIGS. 5, 11 and 12, determined, based on the overhead information in one or more overhead fields such as type (T) field, type (TBD) field, length field, etc., that the sequence of TLVs belong to a big TLV of type (T), obtains a sequence of pieces of payload from the sequence of TLVs and reconstruct or glue the sequence of pieces of payload to recover payload data. Referring to FIG. 2, the receiving node may be a network apparatus having the same or similar network elements, where processor 123 can perform the method at the receiving node.

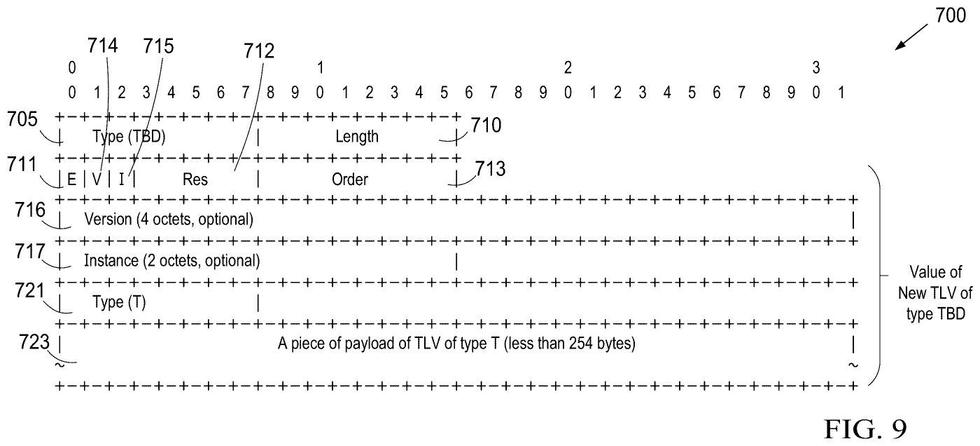

FIG. 9 is a diagram of the format of a container TLV 700 for a big TLV that includes version and instance values according to an embodiment of the disclosure. The container TLV 700 comprises a type field 705 with a value (TBD), a length field 710 with value indicating the size of the TLV excluding the type field 705 and the length field 710, a big TLV identifier field 721 with a value (T) indicating the big TLV to which the piece in TLV 700 belongs, and a piece field 723 containing a piece of payload of the big TLV. The container TLV 700 also includes an E-flag 711, a Res field 712, and an order field 713, as in FIG. 8.

The container TLV 700 further includes a version (V) flag 714, and an instance (I) flag 715. The V-flag 714 comprises one bit. If the V-flag 714 is a “1”, the version field 716 is present. If the V-flag is “0”, the version field 716 is absent. The I-flag 715 comprises one bit. If the I-flag 715 is a “1”, the instance field 717 is present. If the I-flag 715 is “0”, the instance field 717 is absent.

In an embodiment, the version field 716 is used in conveying a particular big TLV in container TLVs. The originating node initializes a 32-bit unsigned integer counter to one for that Big TLV when the node first originates the big TLV and increments the counter by one when the big TLV value is changed and is again distributed.

In an embodiment, the instance field 717 comprises 2 bytes. If a TLV may appear multiple times in an IS-IS Protocol Data Unit (PDU) or Link State PDU (LSP) and in two or more of those instances, the TLV is big, the instance field 717 is used to identify which instance(s) of the big TLVs a particular container TLV is part of.

In an embodiment, the order field 713 of FIG. 9 gives the order of the container TLVs containing pieces/parts of a particular big TLV. Those pieces/parts are sequentially numbered starting at one (or zero) for the first piece/part. Any container TLV whose order field 717 is larger than a container TLV with the E-flag set for the same big TLV may be ignored. Any gap in the order numbering of the container TLVs for a big TLV or lack of a container TLV with one order or lack of a container TLV with the E bit set indicates the big TLV has not been completely received or is corrupt.

If more than one container TLV from the same originating node for the same type (T) have the same order and are in the same PDU or in pieces/parts of the same type of LSP and (1) have the same version number or (2) are in the same PDU and neither includes a version number, then the first occurring such container TLV is used and any subsequent such container TLVs in that PDU or LSP type may be ignored. In an embodiment, “first occurring” means at a smaller offset from the PDU header if in the same PDU or in a lower numbered LSP of the same type if not in the same PDU.

The present disclosure also describes a new flag, called big TLV capability flag (BT for short). When a router distributes its BT with a value of “1”, this BT indicates that the router supports big TLVs. When a router distributes its BT with value of “0”, this BT indicates that the router does not support big TLVs.

In an embodiment, the BT flag may be a bit in the flags field of the SR capabilities sub-TLV (or another existing sub-TLV with a flags field) in a Router Capability TLV. In another embodiment, the BT flag may be a bit in the flags field of a sub-TLV in a Router Capability TLV. The new sub-TLV comprises a type field, a length field and a flags field.

In an embodiment, a first node/router receives the big TLV capability flag in the LSP originated by a second node/router in a network domain. The first node determines whether the payload of a TLV of type (T) to be originated exceeds a maximum value and whether every node in the network domain supports big TLVs. When the payload exceeds the maximum value and every node in the network domain supports big TLVs, the first node splits the payload into n pieces, encodes a first piece of the payload in a normal TLV of type (T) and encodes each of the remaining pieces of the payload in a container TLV. The first node transmits the normal TLV and the container TLVs in one or more LSPs to a neighbor node of the first node.

In an embodiment, a first node/router receives the big TLV capability flag in the LSP originated by a second node/router in a network domain and an encoding of a first big TLV originated by a third node/router in the network domain. The first node determines whether the payload of a TLV of type (T) to be originated exceeds a maximum value and whether every node in the network domain supports big TLVs. When the payload exceeds the maximum value, the first node splits the payload into n pieces, encodes a first piece of the payload in a normal TLV of type (T) and encodes each of the remaining pieces of the payload in a container TLV. The first node transmits the normal TLV and the container TLVs in one or more LSPs to a neighbor node of the first node. When every node in the network domain supports big TLVs, the first node uses the pieces of the payload in the container TLVs for the first big TLV (i.e., uses the second piece to the last piece of the payload in the first big TLV).

There are no restrictions of the lexical order of container TLVs within a packet. If the version and instance fields are included in all container TLVs for a particular big TLV, then there are no restrictions on the distribution of those container TLVs into different packets of an LSP. However, container TLV parts of a particular big TLV in an LSP may be placed in a minimal number of fragments of that LSP so when the big TLV changes, a smaller number of LSP fragments are changed. Also, the purpose of the version field is to be sure that a receiver gets a coherent version of a big TLV. The version may be omitted where practical to save space if either of the following conditions apply:
i) If all the container TLVs with pieces of a particular big TLV are conveyed in the same packet, that is because all of the packet content will be either received or not received. Thus, all of the pieces of a revised big TLV will be received at the same time and be coherent; and
ii) If a big TLV rarely changes and the distribution of any change can be delayed for a bit more than twice the time by which it can be reasonably expected that the previous value may reach all destinations or be expired.

One possible conservative estimate of such a time is MaxAge plus a few seconds. For example, using an architectural constant value of 20 minutes for MaxAge, if it is reasonable to require the distribution of any change to a big TLV not to occur for at least 1,204 seconds (MaxAge+4 seconds) after the last such distribution, then the version field is not needed.

In an embodiment, the originating node may start a timer with such a value when it distributes a changed value in a big TLV and may not distribute another change to any part of that big TLV until that timer expires. A receiving node, to assure that it sees a coherent version of a big TLV, may start a similar but slightly shorter timer, for example, MaxAge+2 seconds (1,202 seconds) when it receives a changed container TLV for a big TLV and wait until that timer has expired before assembling a big TLV from the container TLVs holding that big TLV.

The instance field distinguishes different instances of a big TLV with the same type (T) being distributed simultaneously by an originating node in container TLVs. The instance field is not needed for a big TLV of type (T) that occurs once.

The number of octets of a big TLV in each container TLV may be maximized to reduce the number of container TLVs and thus reduce the overhead of the initial container TLV fields; however, it is unlikely that a big TLV will exactly fill an integer number of container TLVs. Therefore, it is likely that at least one container TLV will not be full. Furthermore, in the case of extended LSPs, the size of a container TLV is normally limited by the packet size which may constrain it to a value such that it is not full.

If a big TLV is actually not big and would have a Length field of 255 or less (or less than will fit in one packet for an extended LSP), the big TLV may not be sent in one or more container TLVs to avoid the overhead of the container TLV headers. However, there may be cases where enforcing this causes undue code path complexity or other problems so a big TLV in a single container TLV with a “0” order field and the E-flag bit set is explicitly permitted.

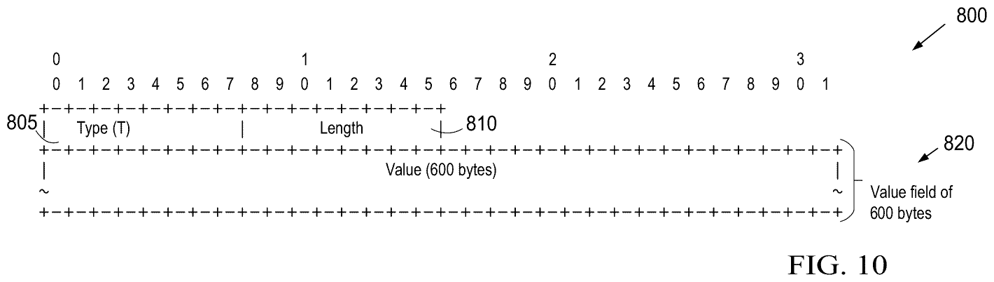

FIG. 10 is a diagram of a big TLV 800 of type (T) with a 600-byte value field 820 according to an embodiment of the disclosure. The big TLV 800 includes a type (T) field 805 and a length field 810. The big TLV 800 cannot be properly originated or processed as a normal IS-IS TLV because its value is 600 bytes, which exceeds the maximum value (e.g., 255).

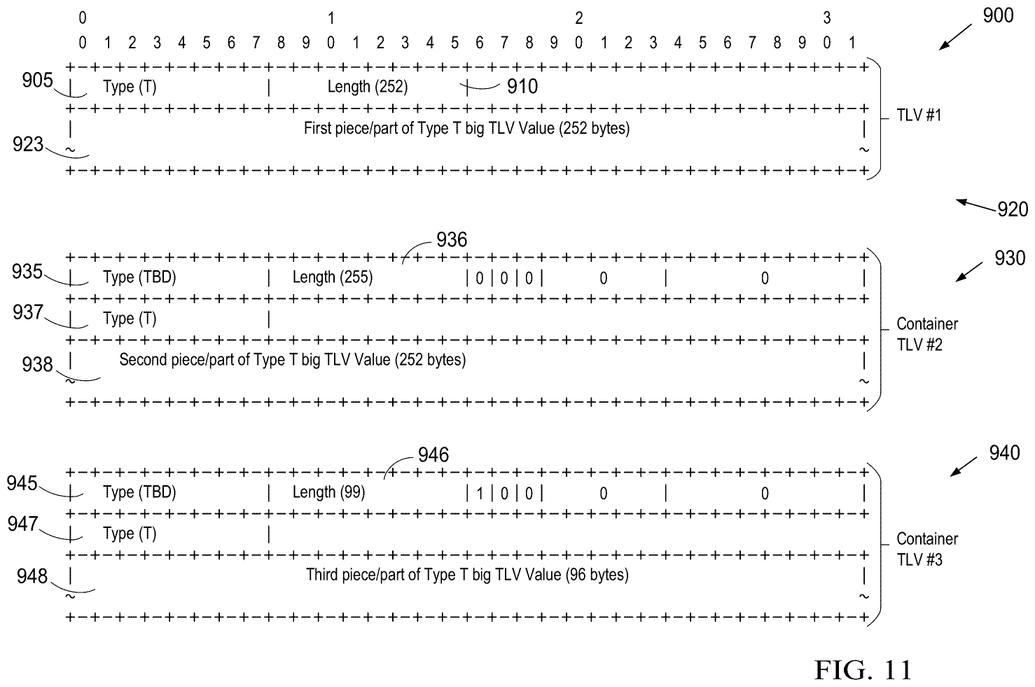

FIG. 11 is a diagram of the encoding 900 of the big TLV 800 of type (T) as a normal TLV 920 of type (T) and two (2) container TLVs 930 and 940 of Type (TBD) according to an embodiment of the disclosure. FIG. 11 shows the encoding 900 as three TLVs suitable for inclusion in one PDU (no version or instance fields needed).

The TLV 920 includes a type (T) field 905, a length field 910, and a first piece 923 of a payload of the big TLV of type (T). The first piece 923 comprises 252 bytes. The container TLV 930 includes a type field 935 with a value (TBD), a length field 936 with value indicating the size of the TLV 930 excluding the type field 935 and the length field 936, a big TLV identifier field 937 with a value (T) indicating the big TLV to which piece 938 belongs, and a second piece 938 of payload of the big TLV. The second piece 938 comprises 252 bytes. The container TLV 940 includes a type field 945 with a value (TBD), a length field 946 with value indicating the size of the TLV 940 excluding the type field 945 and the length field 946, a big TLV identifier field 947 with a value (T) indicating the big TLV to which piece 948 belongs, and a third piece 948 of payload of the big TLV. The third piece 948 comprises 96 bytes. It is noted that the first piece 923, the second piece 938, and the third piece 948 add up to 600 bytes (i.e., 252+252+96=600).

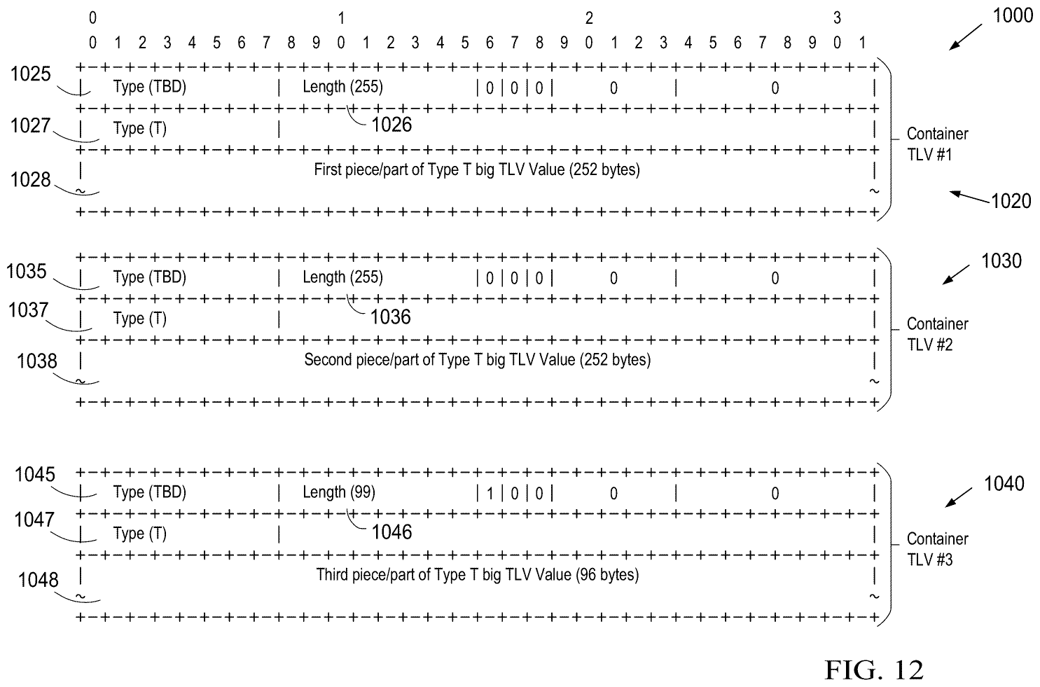

FIG. 12 is a diagram of the encoding 1000 of the big TLV 800 of Type (T) by three (3) container TLVs according to an embodiment of the disclosure. The container TLV 1020 comprises a type field 1025 with a value (TBD), a length field 1026 with value indicating the size of the TLV excluding the type field 1025 and the length field 1026, a big TLV identifier field 1027 with a value (T) indicating the big TLV to which piece 1028 belongs, and a first piece 1028 of payload of the big TLV. The container TLV 1030 comprises a type field 1035 with a value (TBD), a length field 1036 with value indicating the size of the TLV excluding the type field 1035 and the length field 1036, a big TLV identifier field 1037 with a value (T) indicating the big TLV to which piece 1038 belongs, and a second piece 1038 of payload of the big TLV. The container TLV 1040 comprises a type field 1045 with a value (TBD), a length field 1046 with value indicating the size of the TLV excluding the type field 1045 and the length field 1046, a big TLV identifier field 1047 with a value (T) indicating the big TLV to which piece 1048 belongs, and a third piece 1048 of payload of the big TLV. It is noted that the first piece 1028, the second piece 1038, and the third piece 1048 add up to 600 bytes (i.e., 252+252+96=600).

The container TLV has no effect on the normal IS-IS processes such as adjacency and link state update. However, any implementation that does not recognize the container TLV will ignore occurrences of that TLV. If all routers in the flooding scope of an LSP implement the container TLV, then it provides a general capability for including big TLVs of whatever type or types are necessary. If some routers do not implement the container TLV, they will not know of any TLVs sent inside container TLVs.

The container TLV is sufficiently general that it is possible to implement insertion/change/deletion of a big TLV in the local link state and the extraction of big TLVs from the link state database as a separate process without significant change to classic IS-IS processes. However, container TLVs being originated might be assigned to LSP fragments in a more optimized fashion if that assignment process understands container TLVs.

In one embodiment, all the TLVs of normal sizes representing a big TLV of type (T) are in one LSP segment (or one LSP for short). For example, the TLV of type (T) and all the container TLVs of type (TBD) all have a value type (T) with a piece of payload in the big TLV (i.e., (n−1) container TLVs of type (TBD) having values containing piece 2 to piece n respectively) in FIG. 4 are in LSP segment 3 (i.e., LSP 3).

In another embodiment, the TLVs of normal sizes representing a big TLV of type (T) are in two or more LSP segments (or LSPs for short). For example, the TLV of type (T) and all the container TLVs of type (TBD) all have value type (T) with a piece of payload in the big TLV (i.e., (n−1) container TLVs of type (TBD) having values containing piece 2 to piece n respectively) in FIG. 4 are in n LSPs. These n LSPs are LSP 1 to LSP n, where TLV 1, new TLV 2, new TLV 3 up to new TLV n are in LSP 1, LSP 2, LSP 3 to LSP n respectively.

When there is a change in a big TLV of type (T), the router originating the big TLV updates its LSPs containing the TLVs related to the change. In a first embodiment, the change is an addition (e.g., piece n+1) to the end of the payload in the big TLV. The addition is added through a new container TLV (new TLV n+1). The new TLV n+1 is in the same LSP as new TLV n if there is space in the LSP. Otherwise, the new TLV n+1 is in an LSP after the LSP with new TLV n. The LSP with the new TLV n+1 is distributed to other routers in the area. Each of the other routers receives the LSP with the new TLV n+1 and has the latest payload of the big TLV, i.e., piece 1 to piece n and piece n+1 of the payload in the big TLV.

In a second embodiment, the change is a deletion (e.g., deletion of piece k, where k is greater than 1 and less than n+1) from the payload in the big TLV. The deletion is to remove the TLV containing piece k from the LSP. The router originating the big TLV distributes the LSP to other routers in the area. Each of the other routers receives the LSP without the TLV (containing piece k) and has the latest payload of the big TLV (i.e., piece 1 to piece n without piece k).

When k=1 (i.e., deletion of piece 1), if the container TLVs of type (TBD) with sub-TLVs of type (T) (i.e., n container TLVs of type (TBD) with sub-TLVs of type (T) for n pieces in payload of big TLV) as shown in FIG. 6, the deletion is to remove new TLV 1 from the LSP containing new TLV 1. The router originating the big TLV distributes the LSP to other routers in the area. Each of the other routers receives the LSP without the TLV (containing piece 1) and has the latest payload of the big TLV (i.e., piece 2 to piece n without piece 1).

When k=1 (i.e., deletion of piece 1), if the container TLVs of type (TBD) having value starting with type (T) (i.e., (n−1) container TLVs of type (TBD) having value starting with type (T) for piece 2 to piece n in payload of big TLV) as shown in FIG. 5 and FIG. 7 or FIG. 8 or FIG. 0 are in at most (n−1) LSPs. The deletion is to remove TLV 1 from the LSP containing TLV 1 and convert new TLV 2 to TLV 1 in the LSP containing new TLV 2. Converting or promoting the new TLV 2 in FIG. 7 or FIG. 8 or FIG. 9 to TLV 1 is through removing the fields before the type (T) field (such as the type (TBD) and length fields) from new TLV 2, adding a length field after the type (T) field, and setting the length field to the size of the piece (i.e., piece 2).

When a router receives the promoted TLV 1 before the old TLV 1 is removed, the router uses the promoted TLV 1 for the updated big TLV. The payload of the latest big TLV consists of piece 2 to piece n without piece 1. When a router receives the deletion of the old TLV 1 before the promoted TLV 1, the router uses the payloads in new TLV 2 to new TLV n (i.e., piece 2 to piece n) for the updated big TLV. The payload of the latest big TLV consists of piece 2 to piece n without piece 1.

In a third embodiment, the change is a modification (e.g., modification of piece k, where k is greater than 0 and less than n+1) in the payload in the big TLV. The modification is to modify the TLV containing piece k in the LSP; The router originating the big TLV distributes the LSP to other routers in the area. Each of the other routers receives the LSP with the TLV (containing piece k modified) and has the latest payload of the big TLV (i.e., piece 1 to piece n with piece k modified).

In a fourth embodiment, the change is a combination of an addition, deletion and modification. The router originating the big TLV distributes the LSPs reflecting the change to other routers in the area. Each of the other routers receives the LSPs and has the latest payload of the big TLV.

An LSP generation interval is the number of seconds between creating new versions of a given LSP on a per-node basis. It is configurable. Since any LSP generation is controlled by the LSP generation interval, the big TLV changes reflected in the related LSPs are controlled by the LSP generation interval. After a first change on a big TLV is distributed by the originating router to the other routers, a second change on the big TLV will be distributed after at least the LSP generation interval even though the second change happens right after the first change.

If a node supports the container TLV, then for each container TLV with type (T) field received by the node, the node accepts the value following type (T) for container TLV as a piece of payload of a big TLV of type (T). For the TLV of type (T) received, the node accepts the value in the TLV as the first piece of payload of a big TLV of type (T).

Suppose that a node receives one TLV of type (T) and (n−1) container TLVs each of which contains a piece of payload in the big TLV of type (T). The payload in the TLV of type (T) is the first piece of payload of the big TLV of type (T), the piece in the first container TLV is the second piece of payload of the big TLV of type (T), the piece in the second container TLV is the third piece of payload of the big TLV of type (T), . . . , the piece in the (n−1)^{th} container TLV is the n^{th} piece of payload of the big TLV of type (T).

If the piece in the TLV of type (T) is one or more Sub-TLVs and the piece in each of the (n−1) container TLVs is one or more Sub-TLVs, then the piece in the TLV of type (T) is the first piece of payload of a big TLV of type (T), the piece in the first container TLV is the second piece of payload as one or more Sub-TLVs of the big TLV of type (T), the piece in the second container TLV is the third piece of payload as one or more Sub-TLVs of the big TLV of type (T), . . . , the piece in the (n−1)^{th} container TLV is the n^{th} piece of payload as one or more Sub-TLVs of the big TLV of type (T). When there are duplicated Sub-TLVs of the same type, the first Sub-TLV is used and the rest Sub-TLVs of the same type are ignored.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method performed by a routing device, comprising:
determining that a size of a payload of a type-length-value (TLV) of a first type in a link state protocol data unit exceeds a maximum value;
splitting the payload into n pieces, wherein n is an integer larger than 1;
encoding a first piece of the payload in a first TLV of the first type, wherein the first TLV of the first type includes a first type field indicating the first type, a first value field including the first piece of the payload and a first length field indicating a length of the first value field; and
encoding one or more second pieces of the payload in one or more container TLVs of a second type, wherein each container TLV of the second type comprises a second type field indicating the second type, a second value field and a second length field indicating a length of the second value field, and wherein the second value field includes a third type field indicating the first type and a piece field including the second piece of the payload.

2. The method of claim 1, wherein the maximum value is 255 octets, the first value field of the first TLV has a size not larger than the maximum value, and the second value field of each container TLV has a size not larger than the maximum value.

3. The method of claim 1, wherein each container TLV includes at least one of a flag indicating whether the second piece in each container TLV is a final piece of the payload, an order field indicating an order of the second piece of the payload, or an instance field identifying which instance of the TLV the container TLV is part of.

4. The method of claim 1, the method further comprising:
transmitting a TLV capability flag to a neighbor of the routing device, the TLV capability flag indicating supporting a big TLV of the first type including a value field with a size larger than the maximum value.

5. The method of claim 1, wherein the one or more container TLVs follow the first TLV in order without any other TLV therebetween.

6. The method of claim 1, wherein each container TLV includes a big TLV identifier field that includes a value identifying a big TLV to which piece of the payload in the container TLV belongs.

7. The method of claim 1, wherein the piece field includes a value of a big TLV that is being transported in the container TLV.

8. A method performed by a routing device, comprising:
determining that a size of a payload of a type-length-value (TLV) of a first type in a link state protocol data unit exceeds a maximum value;
splitting the payload into n pieces, wherein n is an integer larger than 1; and
encoding the n pieces of the payload in a plurality of container TLVs of a second type, wherein each container TLV includes a second type field indicating the second type, a second value field, and a second length field indicating a length of the second value field, and wherein the second value field of each container TLV includes a third type field indicating the first type and a piece field including a piece of the payload.

9. The method of claim 8, wherein the maximum value is 255 octets, a first value field of a first TLV has a size not larger than the maximum value, and the second value field of each container TLV has a size not larger than the maximum value.

10. The method of claim 8, wherein each container TLV includes at least one of a flag indicating whether the piece in the container TLV is a final piece of the payload, an order field indicating an order of the piece of the payload, or an instance field identifying which instance of the TLV the container TLV is part of.

11. The method of claim 8, the method further comprising:
transmitting a TLV capability flag to a neighbor of the routing device, the TLV capability flag indicating supporting a big TLV of the first type including a value field with a size larger than the maximum value.

12. The method of claim 8, wherein the one or more container TLVs follow a first TLV in order without any other TLV therebetween.

13. The method of claim 8, wherein each container TLV includes a big TLV identifier field that includes a value identifying a big TLV to which the piece of the payload in the container TLV belongs.

14. The method of claim 8, wherein the piece field includes a value of a big TLV that is being transported in the container TLV.

15. A method performed by a routing device, comprising:
receiving a plurality of type-length-values (TLVs) in one or more link state protocol data units, the plurality of TLVs including a first TLV of a first type and one or more container TLVs of a second type, wherein the first TLV of the first type includes a first type field indicating the first type, a first length field indicating a length of a first value field and the first value field including a first piece of a payload, wherein each container TLV of the second type comprises a second type field indicating the second type, a second value field and a second length field indicating a length of the second value field, and wherein the second value field includes a third type field indicating the first type and a piece field including a second piece of the payload;
determining that the plurality of TLVs belong to a big TLV of the first type; and
obtaining a sequence of pieces from the plurality of TLVs to recover the payload.

16. The method of claim 15, wherein a maximum value of the payload is 255 octets, the first value field of the first TLV has a size not larger than the maximum value, and the second value field of each container TLV has a size not larger than the maximum value.

17. The method of claim 15, wherein each container TLV includes at least one of a flag indicating whether the second piece in each container TLV is a final piece of the payload, an order field indicating an order of the second piece of the payload, or an instance field identifying which instance of TLV the container TLV is part of.

18. The method of claim 15, the method further comprising:
receiving a TLV capability flag, the TLV capability flag indicating supporting the big TLV of the first type including a value field with a size larger than the maximum value.

19. The method of claim 15, wherein the one or more container TLVs follow the first TLV in order without any other TLV therebetween.

20. The method of claim 15, wherein each container TLV includes a big TLV identifier field that includes a value identifying the big TLV to which piece of the payload in the container TLV belongs.
